(19) United States
(12) Patent Application Publication
(10) Pub. No.: US 2022/0290818 A1
(43) Pub. Date: Sep. 15, 2022

(54) Energy Storage Using Spherical Pressure Vessel Assembly

(71) Applicant: American Exchanger Services, Inc., Hartford, WI (US)

(72) Inventors: Thomas J. Muldoon, Greenfield, WI (US); Kellen J. Muldoon, Whitefish Bay, WI (US)

(21) Appl. No.: 17/690,585

(22) Filed: Mar. 9, 2022

Related U.S. Application Data
(60) Provisional application No. 63/158,737, filed on Mar. 9, 2021.

(51) Int. Cl. F17C 13/00; F03D 9/17

(52) U.S. Cl. CPC F17C 13/002; F03D 9/17; F17C 2201/0128; F17C 2201/054; F17C 2203/0639; F17C 2205/0142; F17C 2221/031; F17C 2223/036; F17C 2260/031; F17C 2270/0581

(57) ABSTRACT

Systems and methods for improving the efficacy of a wind turbine farm by providing a mechanical compressed air energy storage solution to provide power to the grid when electricity demand requires it. Specifically, a system for storing compressed air energy recovered from a wind turbine driven compressor. The system can include a primary spherical pressure vessel configured for fluid communication with a compressed air source and a secondary spherical pressure vessel in fluid communication with the primary spherical pressure vessel. Air stored in the pressure vessels can then be discharged to a combustion power generator to generate supplemental electrical energy or through a turbo expander to directly generate electricity.

### CROSS-REFERENCE TO RELATED APPLICATION

The present application is based on, claims priority to, and incorporates herein by reference in its entirety, U.S. Provisional Patent Application No. 63/158,737 filed on Mar. 9, 2021 entitled “Energy Storage Using Spherical Pressure Vessel Assembly.”

### STATEMENT OF FEDERALLY SPONSORED RESEARCH OR DEVELOPMENT

Not applicable.

### FIELD OF THE INVENTION

This disclosure relates generally to energy storage for principally wind turbines or wind turbine farms and, specifically, how to increase the efficacy of a wind turbine farm by storing energy in the form of compressed air to level the load. To be clear, wind turbines include wind driven compressors as well as electrical generators.

### BACKGROUND

In some power generation applications, a Compressed Air Energy (“CAES”) facility is utilized as alternatives to batteries or other electrical stores. The CAES facility stores compressed air to be released when demand is needed to drive turbines to produce electricity. Currently, this compressed air is stored in vast underground reservoirs such as caverns, salt cavities, aquifers, mines, or depleted natural gas reservoirs (hereinafter “caverns”).

These conventional means of storing compressed air have distinct drawbacks. For example, caverns, and the other vast underground reservoirs listed above, may not provide a sealed or air-tight environment for compressed air energy storage. In some cases, caverns require expensive treatment or processing to seal the caverns. In other cases, caverns can suffer from degradation caused by fatigue, the “champagne effect” (bubbles), and other natural causes.

In addition, suitable caverns are not available in most geographic locations. For example, in the United States, practically all of the Midwestern region, where the efficacy of wind power is the greatest, the geology is deemed poor for compressed air storage. Caverns can be sensitive to geological features or makeup, such as areas of igneous and metamorphic rocks, volcanic rocks, faulted zones, and zones deemed at risk for seismic activity.

Further, the air in conventional CAES facilities is generally stored at relatively low pressures (low densities). Thus, when attempting to reutilize that air in a combustion power generator, it may require additional compression, requiring large amounts of energy.

In view of the aforementioned problems, the present disclosure provides systems and methods for providing a high pressure, mechanical storage solution for compressed air energy storage.

### SUMMARY

The present disclosure provides systems and methods for improving the efficiency of a power plant by providing a rechargeable source of high pressure compressed air from a series of pressure vessels.

According to one aspect, the present disclosure provides a system for storing compressed air energy recovered from a wind turbine driven compressor. The system can include a primary spherical pressure vessel configured for fluid communication with a compressed air source and one or more secondary spherical pressure vessels in fluid communication with the primary spherical pressure vessel. The primary and one or more secondary spherical pressure vessels are configured to store compressed air up to 15,000 psi (i.e., resulting in compressed air stored at a very high density).

According to another aspect, the present disclosure provides a compressed air energy storage tank. The compressed air energy storage tank comprises a primary pressure vessel, and a plurality of secondary pressure vessels in fluid communication with the primary pressure vessel and arranged in a pattern around the primary pressure vessel. A first pressure vessel and a second pressure vessel among the plurality of secondary pressure vessels are circumferentially spaced apart from each other by about 30 degrees. The primary pressure vessel and the plurality of secondary pressure vessels are spherical tanks.

According to another aspect, the present disclosure provides a power generation system for use with a wind turbine. The power generation system comprises a compressor operably coupled to a shaft driven by the wind turbine, a compressed air energy storage (“CAES”) tank in fluid communication with the compressor for receiving pressurized air provided by the compressor, and a combustion power generator including a combustion chamber in fluid communication with a fuel source and the CAES tank to receive and combust a mixture of a fuel and the pressurized air from the CAES tank. The CAES tank includes a primary pressure vessel, and a plurality of secondary pressure vessels in fluid communication with the primary pressure vessel and arranged in a pattern around the primary pressure vessel. A first pressure vessel and a second pressure vessel among the plurality of secondary pressure vessels are circumferentially spaced apart from each other by about 30 degrees. The primary pressure vessel and the plurality of secondary pressure vessels are spherical tanks.

These and still other advantages of the invention will be apparent from the detailed description and drawings. What follows is merely a description of some preferred embodiments of the present invention. To assess the full scope of the invention the claims should be looked to as these preferred embodiments are not intended to be the only embodiments within the scope of the claims.

### BRIEF DESCRIPTION OF THE DRAWINGS

FIG. 1 is a schematic of a wind turbine power plant with a compressed air energy storage tank incorporated as the supporting tower structure according to one aspect of the present disclosure. This power plant also demonstrates how the heat of combustion can be used to further enhance the overall power plant efficiency including a combined cycle heat recovery steam generator power generator. It should be noted that in traditional combustion turbines uses almost half.

FIG. 2 is a schematic of a wind turbine with an integrated compressor according to one aspect of the present disclosure.

FIG. 3 is a schematic of a centrifugal compressor according to one aspect of the present disclosure.

FIG. 4 is a schematic of a radial compressor according to one aspect of the present disclosure.

FIG. 5 is a schematic of a rotary compressor according to one aspect of the present disclosure.

FIG. 6 is a schematic of a wind turbine farm including a compressed air energy storage tank according to one aspect of the present disclosure.

FIG. 7 is a top view of the compressed air energy storage tank of FIG. 6.

FIG. 8 is a side view of the compressed air energy storage tank of FIG. 6.

FIG. 9 is a schematic illustration of one tank among a plurality of tanks of the compressed air energy storage tank of FIG. 6 having pellets stored therein.

FIG. 10 is a side view of a wind turbine with an integrated compressed air energy storage tank.

FIG. 11 is a top-down view of a base of the wind turbine of FIG. 9 with an integrated compressed air energy storage tank from the perspective of line A-A.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

Unless otherwise specified or limited, the terms “about” and “approximately,” as used herein with respect to a reference value, refer to variations from the reference value of ±15% or less, inclusive of the endpoints of the range.

According to some aspects, devices or systems disclosed herein can be utilized, manufactured, installed, etc. using methods embodying aspects of the invention. Correspondingly, any description herein of particular features, capabilities, or intended purposes of a device or system is generally intended to include disclosure of a method of using such devices for the intended purposes, of a method of otherwise implementing such capabilities, of a method of manufacturing relevant components of such a device or system (or the device or system as a whole), and of a method of installing disclosed (or otherwise known) components to support such purposes or capabilities. Similarly, unless otherwise indicated or limited, discussion herein of any method of manufacturing or using for a particular device or system, including installing the device or system, is intended to inherently include disclosure, as embodiments of the invention, of the utilized features and implemented capabilities of such device or system

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

Although some examples of systems and method are provided below, it should be appreciated that these systems and methods are exemplary, but not limiting.

Wind Turbine-Driven Compressor

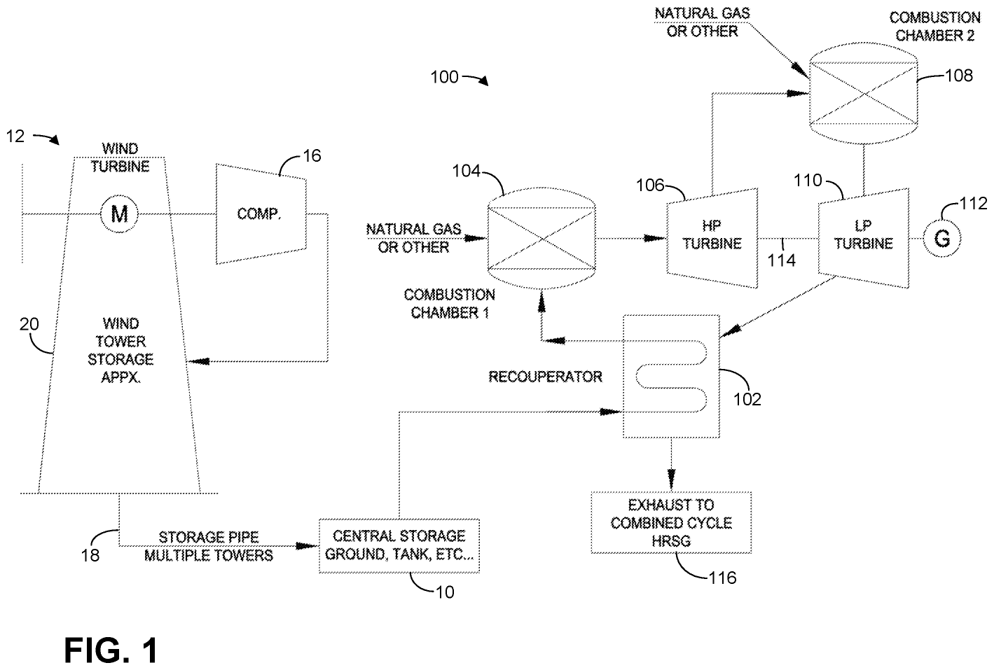

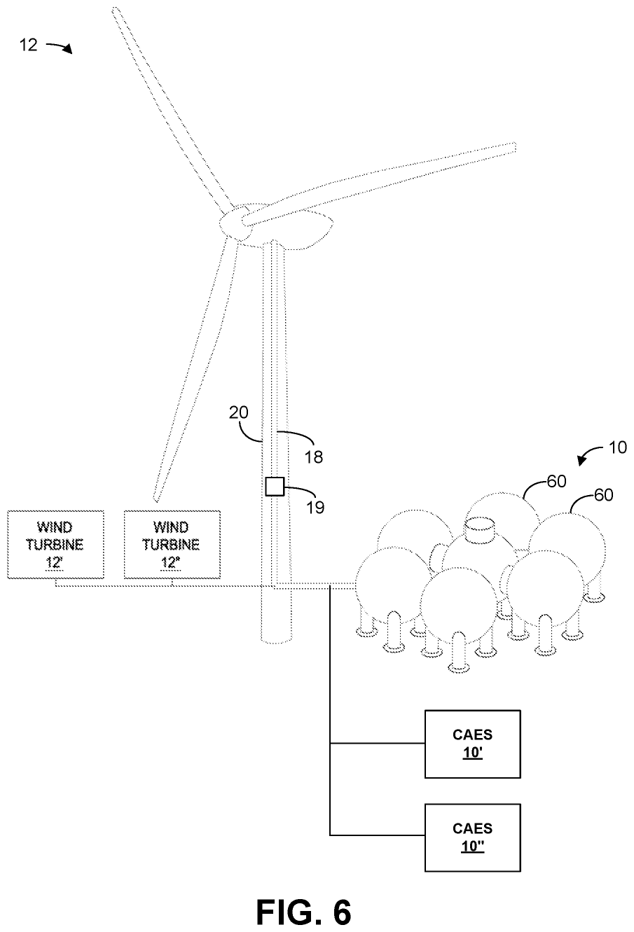

As shown in FIG. 1, a wind turbine power plant can include a compressed air energy storage tank 10, a wind turbine 12, and a power generator 100. As will be described in greater detail below, the wind turbine 12 can include a compressor 16 operably coupled to and driven by the wind turbine 12. The compressor 16 can provide pressurized air to the compressed air energy storage tank 10. For example, pipes 18 can be in fluid communication with an outlet of the compressor 16 and the compressed air energy storage tank 10 to provide a conduit for the pressurized air and, in some cases, include a check valve 19 (see FIG. 6) along the pipe 18 to provide compressed air into the tanks 10, but prevent compressed air from travelling back into the compressor 16. In the illustrated embodiment, a body 20 of the wind tower can be in fluid communication with the compressor 16 to store pressurized air within the body 20. The pipes 18 can be in fluid communication with the body 20 and the compressed air energy storage tank 10 to transfer pressurized air therebetween. In its simplest embodiment the supply of air to a standard combustion turbine can be done by the stored air in the compressed air energy storage tank 10. This eliminates half the energy loss associated with the compression of air in the power generator 100 prior to ignition, due to the removal of a compressor driven by the turbine, as will be further described herein.

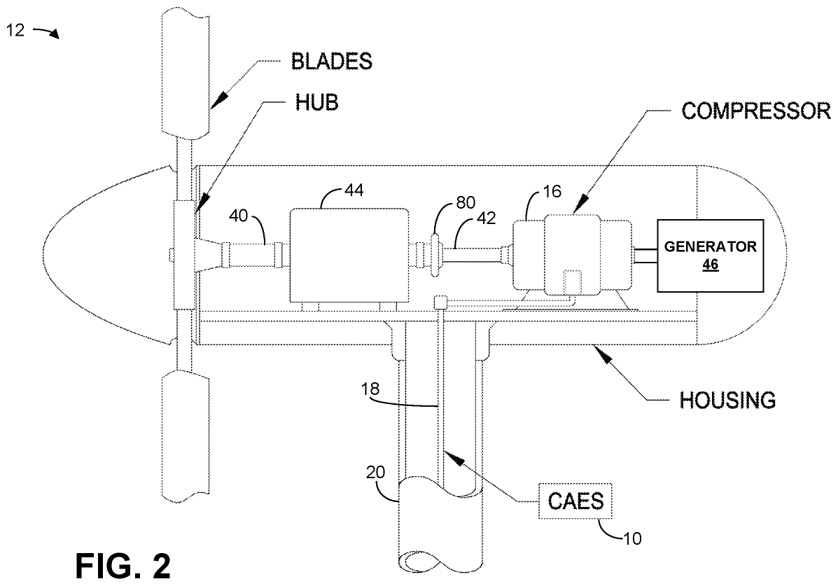

Looking now to FIG. 2, the wind turbine 12 can include blades coupled to a hub. The blades, as is known in the art, cause rotation of the hub when wind passes over the blades. The hub is coupled to a shaft 40 to for rotation therewith. In the illustrated embodiment, the shaft 40 can be coupled to a high-speed shaft 42 through a gearbox 44. The high-speed shaft 42 has traditionally been coupled to a generator 46 for converting the rotational energy of the shaft 42 to electrical energy. In the illustrated embodiment, however, a compressor 16 can additionally or alternatively be directly coupled to or otherwise driven by the wind turbine 12 (e.g., by the high-speed shaft 42). According to some embodiments, the compressor 16 can be directly coupled to the high-speed shaft 42 in place of the generator 46. According to other embodiments, the high-speed shaft 42 can drive the compressor 16 and the generator 46, including selectively switching between driving either the compressor 16 or the generator 46 (e.g., via a clutch 80). The compressor 16 can be configured for generating compressed air and then discharging that compressed air into one or both of the body 20 (e.g., tower) of the wind turbine 12 and the compressed air energy storage tank 10 via pipes 18.

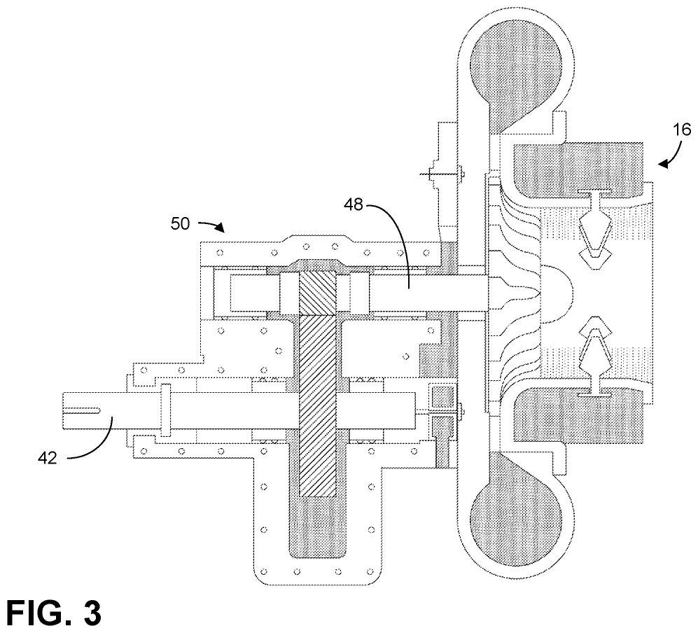

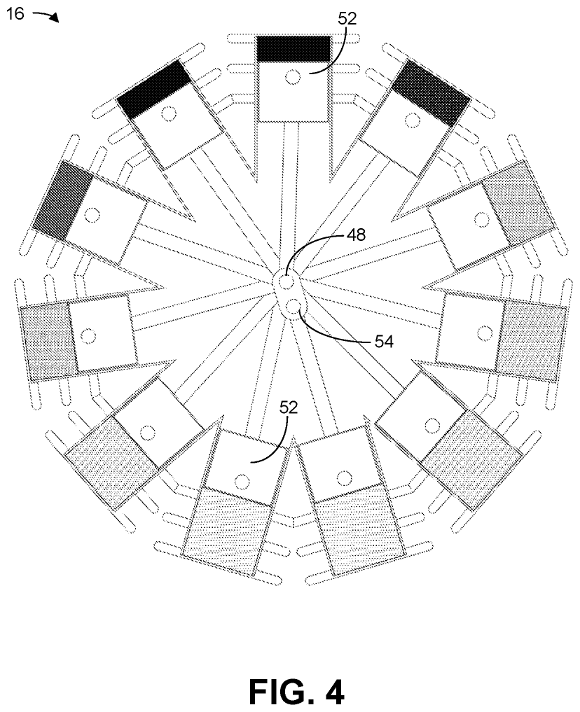

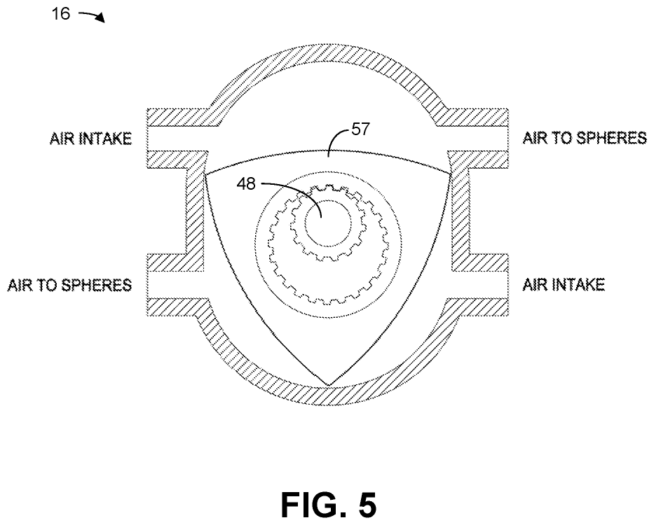

Looking now towards FIGS. 3-5, the wind driven compressor 16 may be embodied in various forms. In the embodiment illustrated in FIG. 3, the compressor 16 is a centrifugal style compressor. The compressor shaft 48 is coupled to the high-speed shaft 42 of the wind turbine 12 (see FIG. 2) through a gear train 50 for rotation therewith. In the embodiment illustrated in FIG. 4, the compressor 16 is a radial style piston compressor. The compressor shaft 48 is coupled to a plurality of pistons 52 through a crankshaft 54. More than one circumferential set of rotary pistons may be employed to get the pressures to very high levels. For example, the compressor 16 of FIG. 4 can be a first circumferential set of rotary pistons and additional circumferential sets of rotary pistons can be axially aligned with the first circumferential set of rotary pistons, in which each circumferential set can be driven by a common shaft. The shaft may be split between circumferential sets and connected via a transmission. In the embodiment illustrated in FIG. 5, the compressor 16 is a rotary compressor of a lobed (Wankel)-style design. The compressor shaft 48 is coupled to a triangular piston 57. In the embodiments illustrated in FIGS. 4 and 5, rotation of the compressor shaft 48 is configured to drive the pistons 52, 57 to provide compressed air. The rotary compressor embodiment of FIG. 5 keeps the weight lower than a piston design, such as that illustrated in FIG. 4.

As previously described herein, the pressurized air provided by the compressors can be stored in a compressed air energy storage facility, and the conventional compressed air energy storage facilities have distinct drawbacks. A mechanical storage solution for compressed air energy storage is needed. One particular problem with compressed air energy storage is that they are required to store a large mass of air. For example, a 250 MW power plant may require 100,000,000 lbs. of air to be stored in the compressed air energy storage facility. To accomplish this requirement using conventional methods, the required volume would be about 39.3 million cubic feet when stored at 500 psi. Thus, conventional methods require vast underground reservoirs that can succumb to the aforementioned drawbacks.

The compressed air energy storage tank 10 or spherical “power balls” design described below overcomes these drawbacks by providing a pressure vessel capable of storing air at very high pressures. In particular, a spherical shaped tank can hold pressures using a wall thickness of the tank that is about half the thickness of cylinders. Utilizing the same example as above, 100,000,000 lbs. of air could be stored within only 3.3 million cubic feet when stored at 6000 psi. Further, the pressure vessel can be placed above ground, which can provide easier access for maintenance and inspection.

High Pressure CAES Tank

FIG. 6 illustrates one embodiment of a high pressure compressed air energy storage tank 10 (as well as additional tanks 10′, 10″ illustrated schematically which can be otherwise identical to tank 10 as depicted). As previously described herein, a compressed air energy storage tank 10 can be in fluid communication with a compressor (see FIG. 2) via pipes 18. In the illustrated embodiment, the compressed air energy storage tank 10 can be in fluid communication with a one or a plurality of compressors driven by a plurality of corresponding wind turbines 12, 12′, 12″ (with turbines 12′, 12″ being illustrated schematically and which can be otherwise identical to wind turbine 12 as depicted). Additionally or alternatively, one or more wind turbines 12, 12′, 12″ can be in fluid communication with a plurality of compressed air energy storage tanks 10, 10′, 10″ to provide increased storage capacity. In these ways, the energy from a compressor driven by a single wind turbine, or compressors driven by multiple wind turbines, can be stored in single or multiple high pressure compressed air energy storage tanks. The fluid communication between the plurality of wind turbines and the plurality of compressed air energy storage tanks can be accomplished via a network of pipes 18 (e.g., manifolds).

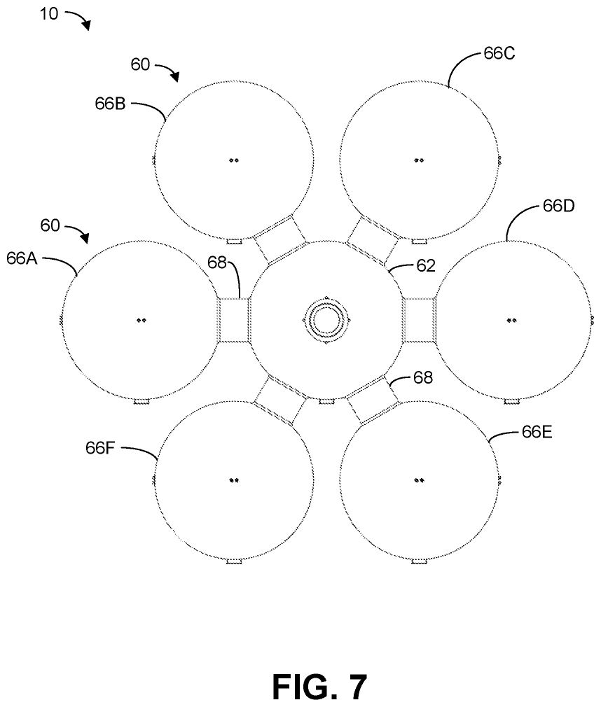

Referring now to FIGS. 7-9, the compressed air storage tank 10 can include one or more spherical pressure vessels 60 (see also, FIG. 6 showing a perspective view of the tank arrangement). The spherical pressure vessels 60 can be manufactured from steel. The steel construction of the spherical pressure vessels 60 can provide resistance to degradation that can be a plague to the conventional CAES caverns previously described. Spherical containers can handle almost double the magnitude of pressures than a cylindrical vessel of the same thickness. Multi-layered vessels may also be utilized to get to higher pressure and increased lbs. of air storage. According to some examples, the spherical pressure vessels 60 can be manufactured from other metal alloys, fiberglass, or carbon fiber, including in combination with steel or another metal alloy as additional layers of a wall of the spherical pressure vessel 60. The spherical pressure vessels can be configured to be ultra-high pressure vessels which can store air between about 4,000 and about 15,000 psi. In some embodiments, the pressure vessels can be configured to store air between about 5,000 and about 8,000 psi. The spherical pressure vessels 60 can define a diameter between about 4 ft. and about 15 ft. In some embodiments, the spherical pressure vessels 60 can define a diameter between about 5 ft. and about 7 ft.

The spherical pressure vessels 60 can be configured to be above ground and can be supported by one or more support legs 61. In the illustrated embodiment, each of the spherical pressure vessels 60 can include four support legs 61 coupled thereto. The support legs 61 can be couple to a surface (e.g., concrete) via appropriate fastening methods (e.g., concrete anchors). The spherical pressure vessels 60 can also include an access hatch 63 on a bottom side of each of the spherical pressure vessels 60.

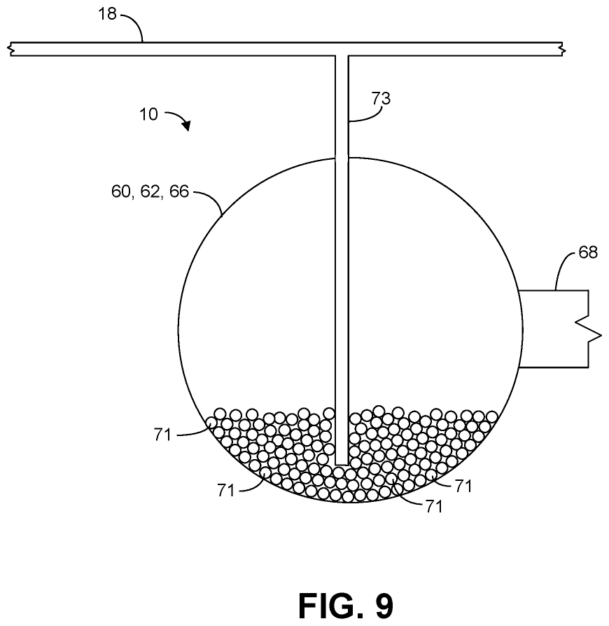

According to some embodiments, it may be desirable to store or retain heat caused by compression within the compressed air stored in the spherical pressure vessels 60. To accomplish this, at least one of the spherical pressure vessels 60 can include an integrated adiabatic energy storage device configured to retain heat, and thereby keep the air stored within the spherical pressure vessels at an elevated temperature for as long as possible. For example, the integrated adiabatic energy storage device can be configured as a plurality of iron or steel (or other metal) pellets 71 (see FIG. 9) can be stored within the spherical pressure vessels 60. The pellets 71 can be spherical, cylindrical, cubic, rectangular, or any other geometric shape. According to another example, the integrated adiabatic energy storage device can be configured as metal shavings stored within the spherical pressure vessel. For example, metal shavings recovered from machining processes can be utilized (including recycled shavings created during machining of the vessels 60). During filling of the spherical pressure vessels 60, the air is heated during compression and the pellets 71 can retain the heat energy for long periods of time. During discharge of spherical pressure vessels 60, the compressed air can be preheated by the pellets 71 (or by flowing the air over a bed of the hot iron pellets in a chamber in fluid communication with an outlet of the spherical pressure vessels 60). In some embodiments, an internal pipe 73 in fluid communication with the pipes 18 from the compressor 16 (see FIG. 2) can feed the compressed air through the bed of pellets. The pellets can absorb and retain heat from the compressed air, which may prevent or reduce the need to preheat the compressed air for later use in combustion processes. In the illustrated embodiment, the pellets 71 can fill a bottom portion of the spherical pressure vessel up to a predetermined depth, and the outlet of the internal pipe 73 can be below the predetermined depth in order to provide air into the collection of pellets 71. Alternatively, the internal pipe 73 can be in fluid communication with a power generator 100 (see, e.g., FIG. 1), and as such air exiting the spherical pressure vessel 60 can pass through the pellets 71 prior to entering the pipe 73 to be delivered to the power generator 100.

In the illustrated embodiment, the compressed air storage tank 10 can include a primary spherical pressure vessel 62. The primary spherical pressure vessel 62 can include an inlet 64 for receiving pressurized air from a compressed air source, such as the compressors 16 previously described herein. The primary spherical pressure vessel 62 can be in fluid communication with a plurality of secondary spherical pressure vessels 66. In the illustrated embodiment, the compressed air storage tank 10 includes one primary spherical pressure vessel 62 and six secondary spherical pressure vessels, including first, second, third, fourth, fifth, and sixth secondary spherical pressure vessels 66A, 66B, 66C, 66D, 66E, 66F. In other embodiments, the compressed air storage tank 10 can include between 2 and 10 secondary spherical pressure vessels 66. The plurality of secondary spherical pressure vessels 66 can be arranged in a pattern around the primary spherical pressure vessel 62. In the illustrated embodiment, the plurality of secondary spherical pressure vessels 66 can be circumferentially separated from each other by about 60 degrees with respect to the centrally located primary spherical pressure vessel 62 (e.g., a hexagonal close-packed arrangement), albeit with short connecting tubular crossover pipes 68 to space the vessels 60 radially apart from one another. In other embodiments, the plurality of secondary spherical pressure vessels 66 can be circumferentially separated from each other by between about 30 degrees to about 180 degrees. The circumferential spacing can be dependent on spatial constraints of the area in which the compressed air storage tank 10 is to be installed, and/or dependent upon the number of secondary spherical pressure vessels 66.

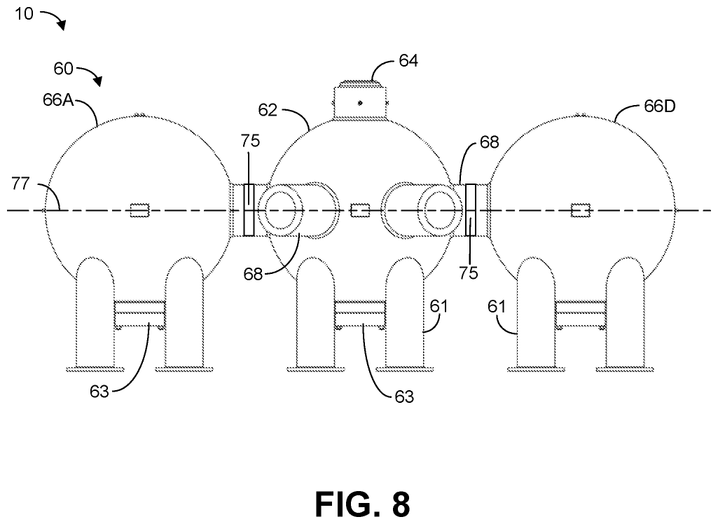

The fluid communication between the primary and secondary spherical pressure vessels 62, 66 can be provided by a crossover pipe or conduit 68 designed for maximum pressure. In the illustrated embodiment, a cross over pipe 68 is provided for each of the secondary spherical pressure vessels 66. The crossover pipe 68 can include a critical flow device 75 arranged in the crossover pipe 68 between a secondary spherical pressure vessel 66 and a primary spherical pressure vessel 62. As schematically illustrated (see FIG. 8), the critical flow device 75 is configured as an interconnect seal using a critical flow orifice. The interconnect seal can be configured to prevent flow through the crossover pipe 68 in the event of a leak in the corresponding secondary spherical pressure vessel 66. For example, the interconnect seal can shut if flow through the crossover pipe 68 reaches a predetermined critical flow threshold. When flow through the crossover pipe 68 reaches the predetermined critical flow threshold, a pressure drop across the interconnect seal can force the interconnect seal to close.

As illustrated in FIG. 8, the second, third, fifth, and sixth secondary spherical pressure vessels 66B, 66C, 66E, and 66F are not illustrated for clarity. In the illustrated embodiment, the spherical pressure vessels 60, including the primary and secondary spherical pressure vessels 62, 66 can be arranged in a common horizontal plate 77 (e.g., relative to a ground plane defined by the ground surface). That is, a geometric center of each of the plurality of spherical pressure vessels 60 can be arranged in a common horizontal plane 77. According to other embodiments, the primary spherical pressure vessel 62 can be arranged in a first horizontal plane and the secondary spherical pressure vessels can be arranged in a second horizontal plane, vertically offset from the first horizontal plane.

It is contemplated that in some forms, the pressure vessels can be outfitted with cooling jackets or other cooling mechanisms as part of the vessels, as heat may be generated when the pressure is increased in the vessels and this heat may need to be quickly dissipated.

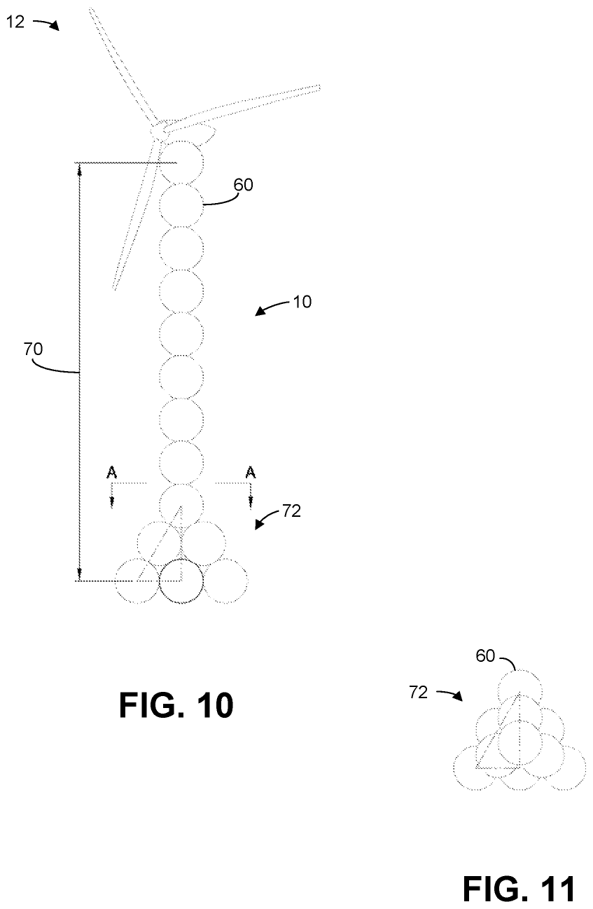

Looking now to FIGS. 10-11, an embodiment of a wind turbine 12 is illustrated where a body of the wind turbine includes or is formed from a plurality of spherical pressure vessels 60. In some embodiments, the structure of the wind turbine 12 can be formed from the spherical pressure vessels 60. In another embodiments, the spherical pressure vessels can be housed within a body of the wind turbine 12 (see, e.g., body 20 of FIG. 2). In the illustrated embodiment, the tower 70 of the wind turbine 12 can include a single row of spherical pressure vessels 60 stacked in series between the head of the wind turbine 12 to a base 72 of the wind turbine 12. The base 72 of the wind turbine 12 can include a plurality of spherical pressure vessels 60 “stacked” in the form of a pyramid (see FIG. 11).

Power Recovery Methods Using Combustion

Looking back at FIG. 1, the compressed air stored in the compressed air energy storage tank 10 can be discharged and reutilized in combustion processes to provide supplemental electrical power. In general, the compressor 16 coupled to the wind turbine 12 can operate as a standard wind turbine during normal electrical demand conditions. During “off-peak” or low demand conditions, such as at night when electrical demand is low, the wind turbine can begin a compression storage cycle to begin filling the CAES tank 10. With the CAES tank 10 is pressurized, the compressed air can be reutilized as an input into combustion power generators (e.g., a combustion turbine, or a gas or turbo expander turbine) for generating electricity during “peak” or high-demand conditions. This reutilization of compressed air on an on-demand basis can improve the efficiency of power plants in numerous ways. For example, the ability to generate additional power can remove the variation in wind turbine electrical output, which is generally considered the biggest single obstacle for wind power. The compressed air energy is stored in a CAES tank, which can then be reutilized for power, as opposed to energy storage in batteries. In addition, supplying pre-compressed air into a combustion power generator can decrease fuel demand by up to 50%, greatly reducing the operation cost.

The wind turbine 12 can begin a compression storage cycle by driving the compressor 16. According to some embodiments, engagement of the compressor can be done using a mechanical disconnect, such as a clutch 80, in line with either the high speed shaft 42 (FIG. 2) or the compressor shaft 48 (FIG. 3). During the compression storage cycle, the compressor 16 can begin pressurizing one or both of the body 20 of the wind turbine 12 or the compressed air energy storage tank 10. According to some embodiments, the compressor 16 may first pressurize the body 20 of the wind turbine 12 to a first predetermined pressure threshold (e.g., 500 psi). When the body 20 is pressurized at the first predetermined pressure threshold, the compressor may begin to pressurize the compressed air energy storage tank 10 to a second predetermined pressure threshold (e.g., between 4,000 and 15,000 psi). According to some embodiments, the compressor 16 only pressurizes the compressed air energy storage tank 10.

The compressed air stored in the CAES tank 10 can then be utilized for generating electricity in a combustion power generator 100. The pressurized air stored in either the compressed air energy storage tank 10 or the body 20 of the wind turbine 12 may then be utilized by the power generator 100 to generate electricity via a combustion process. In the illustrated embodiment, pressurized air from the compressed air energy storage tank 10 is routed to a recouperator 102 to preheat the air prior to combustion. After the pressurized air passes through the recouperator 102, it can be mixed with a fuel (e.g., natural gas, hydrogen gas, or other gas) in a first combustion chamber 104. The products of combustion can then be sent through a high-pressure turbine 106 to drive a shaft 114. The exhaust from the high-pressure turbine 106 can be sent into a second combustion chamber 108 and again mixed with fuel and combusted. The products of combustion can then be sent through a low-pressure turbine 110 to drive the shaft 114. The exhaust from the low-pressure turbine 110 can be sent through the recouperator 102 to preheat the air entering the power generator 100 and then exhausted to other power plant components, such as a heat recovery steam generator 116. As noted above, the high and low-pressure turbines 106, 110 are coupled to a common shaft 114. A generator 112 for generating electrical energy is coupled to the shaft 114 and driven by the high and low-pressure turbines 106, 110. In that way, the compressed air stored in the compressed air energy storage tank 10 can be utilized for electrical power generation. According to other examples, the pressurized air from the compressed air energy storage tank 10 can be provided directly to a turbine to drive a generator (e.g., without being combusted in a combustion chamber).

It should be appreciated that various other modifications and variations to the preferred embodiments can be made within the spirit and scope of the invention. Therefore, the invention should not be limited to the described embodiments. To ascertain the full scope of the invention, the following claims should be referenced.

What is claimed is:

1. A system for storing compressed air energy recovered from a wind turbine driven compressor, the system comprising:
a primary spherical pressure vessel configured for fluid communication with a compressed air source; and
one or more secondary spherical pressure vessels in fluid communication with the primary spherical pressure vessel;
wherein the primary spherical pressure vessel and the one or more secondary spherical pressure vessels are configured to store compressed air up to 15,000 psi.

2. The system of claim 1, wherein the primary pressure vessel and the one or more secondary spherical pressure vessels are configured to store compressed air of at least 4,000 psi.

3. The system of claim 1, wherein walls of the primary spherical pressure vessel and the one or more secondary spherical pressure vessels comprise steel.

4. The system of claim 1, further comprising a plurality of metal pellets stored within at least one of the primary spherical pressure vessel or one of the one or more secondary spherical pressure vessels.

5. The system of claim 1, wherein the one or more secondary spherical pressure vessels includes a plurality of secondary spherical pressure vessels, wherein each one of the plurality of secondary spherical pressure vessels is in fluid communication with the primary spherical pressure vessel.

6. The system of claim 5, wherein the plurality of secondary spherical pressure vessels is arranged in a hexagonal pattern surrounding the primary spherical pressure vessel.

7. The system of claim 5, wherein the plurality of secondary spherical pressure vessels and the primary spherical pressure vessel are arranged in a common horizontal plane.

8. The system of claim 5, wherein the primary spherical pressure vessel is centrally located among the plurality of secondary spherical pressure vessels; and
wherein a first spherical pressure vessel and a second spherical pressure vessel among the plurality of secondary spherical pressure vessels are circumferentially spaced apart from each other by about 30 degrees.

9. The system of claim 1, wherein the fluid communication between the primary spherical pressure vessel and the one or more secondary spherical pressure vessels is provided by a crossover pipe such that the pressure is equalized in the primary spherical pressure vessel and the one or more secondary spherical pressure vessels.

10. The system of claim 9, wherein the crossover pipe includes a critical flow device configured to reduce backflow from the primary spherical pressure vessel to a corresponding secondary spherical pressure vessel.

11. The system of claim 10, wherein the critical flow device is configured to inhibit flow through the crossover pipe when the flow therethrough reaches a predetermined flow threshold.

12. A compressed air energy storage tank comprising:
a primary pressure vessel; and
a plurality of secondary pressure vessels in fluid communication with the primary pressure vessel and arranged in a pattern around the primary pressure vessel;
wherein a first pressure vessel and a second pressure vessel among the plurality of secondary pressure vessels are circumferentially spaced apart from each other by about 30 degrees; and
wherein the primary pressure vessel and the plurality of secondary pressure vessels are spherical tanks.

13. The tank of claim 12, wherein the primary pressure vessel and the plurality of secondary pressure vessels are configured to store compressed between about 4,000 psi and about 15,000 psi.

14. The tank of claim 12, wherein each of the primary pressure vessel and the plurality of secondary pressure vessels define a diameter between about 5 ft. and about 7 ft.

15. The tank of claim 12, wherein the plurality of secondary pressure vessels is arranged in a hexagonal pattern surrounding the primary pressure vessel.

16. The tank of claim 12, wherein the plurality of secondary pressure vessels and the primary pressure vessel are arranged in a common horizontal plane.

17. The tank of claim 12, wherein the fluid communication between the primary pressure vessel and the plurality of secondary pressure vessels is provided by a crossover pipe arranged between each of the plurality of secondary pressure vessels and the primary pressure vessel.

18. The tank of claim 12, further comprising a plurality of metal pellets stored within at least one of the primary pressure vessel or one of the plurality of secondary pressure vessels.

19. A power generation system for use with a wind turbine, the power generation system comprising:
a compressor operably coupled to a shaft driven by the wind turbine;
a compressed air energy storage (“CAES”) tank in fluid communication with the compressor for receiving pressurized air provided by the compressor; and
a combustion power generator including a combustion chamber in fluid communication with a fuel source and the CAES tank to receive and combust a mixture of a fuel and the pressurized air from the CAES tank;
the CAES tank including:
a primary pressure vessel; and
a plurality of secondary pressure vessels in fluid communication with the primary pressure vessel and arranged in a pattern around the primary pressure vessel;
wherein a first pressure vessel and a second pressure vessel among the plurality of secondary pressure vessels are circumferentially spaced apart from each other by about 30 degrees; and
wherein the primary pressure vessel and the plurality of secondary pressure vessels are spherical tanks.

20. The power generation system of claim 19, wherein the fuel is natural gas or hydrogen gas.
